(19) United States
(12) Patent Application Publication
(10) Pub. No.: US 2022/0162889 A1
(43) Pub. Date: May 26, 2022

(54) ROTARY LATCH

(71) Applicant: Industrilås i Nässjö AB, Nässjö (SE)

(72) Inventor: Adam Linnåsen, NÄSSJÖ (SE)

(21) Appl. No.: 17/434,403

(22) PCT Filed: Mar. 25, 2021
(86) PCT No.: PCT/EP2020/058357

§ 371 Date: Aug. 26, 2021

(30) Foreign Application Priority Data
Mar. 28, 2019 (EP) 19165907.7

(51) Int. Cl. E05C 3/24; E05B 85/24; E05B 85/26

(52) U.S. Cl. CPC E05C 3/24; E05B 85/26; E05B 85/243

(57) ABSTRACT

This present disclosure relates to a rotary latch assembly (1). The rotary latch assembly comprises: a latch (2) rotatable about a first rotational axis (R1) between a striker releasing position (L1) in which the latch (2) is positioned to release a striker (20X), and a striker retaining position (L2) in which the latch (2) is adapted to retain the striker (20X), a pawl (3) rotatable about a second rotational axis (R2) between a latch engaging position (P1) in which the pawl (3) is adapted to engage with the latch (2) by means of an engaging member (6), and a latch disengaging position (P2) in which the engaging member (6) is disengaged from the latch (2), and a latch biasing member (4) adapted to bias the latch (2) toward the striker releasing position (L1), and a pawl biasing member (5) adapted to bias the pawl (3) toward the latch engaging position (P1), wherein the engaging member (6) is a rotatable member rotatable about a rotation axle, and adapted to provide a rotatable interface (60) between the latch (2) and the pawl (3) to facilitate the latch (2) and the pawl (3) to move relative each other, wherein at least one of the latch biasing member (4) and the pawl biasing member (5) is a torsion spring with a portion (40, 50) that serves as the rotation axle of the rotatable member (6).

### TECHNICAL FIELD

The present disclosure relates to a rotary latch assembly and in particular to a rotary latch assembly for vehicles.

### BACKGROUND

The doors in vehicles are required to be securely shut during transit. As a securing means, a rotary latch assembly may be used. Generally, rotary latch assemblies are adapted to be arranged to a door to engage with a striker attached to the corresponding door frame, for instance by means of a latch adapted to receive and retain the striker, and a pawl adapted to lock the latch in a position where it retains the striker. By this, the striker can only be released by the latch if the pawl is disengaged from the latch.

One advantage of rotary latch assemblies is that they can be realized in a relatively compact form factor which is beneficial since the mounting space in vehicles is limited. To realize a compact rotary latch assembly, the amount of unused space in-between its components must be reduced. In addition, the internal clearance in-between components moving relative each other, for instance the latch and the pawl, can be reduced also. Some manufacturers opt for a very tight fitting in order to add a certain rigidness to the rotary latch assembly, which can increase its durability. However, a tight fitting can cause more friction, causing the rotary latch assembly to be more difficult to open or close.

How easily a rotary latch assembly can open or close can be characterized in terms of rotary resistance, i.e. the resistance an opening force or a closing force acting on the rotary latch assembly must overcome in order to position the rotary latch assembly in an open state or a closed state, respectively. The rotary resistance is affected by, for instance, internal frictional forces as well as biasing forces acting on the components of the rotary latch assembly, in particular the latch and the pawl.

Due to the common compactness of rotary latch assemblies, the associated rotary resistance is large because of the frictional forces acting within the rotary latch assembly.

One way of reducing the rotary resistance is to reduce the friction in-between components. This may be done by increasing the internal clearance in-between said components. However, this enables debris to get stuck within the rotary latch assembly, which can possibly impair its functionality.

One other way of reducing the rotary resistance is to incorporate biasing means, such as springs, which are adapted to apply biasing forces on the latch and pawl in either an opening or closing direction, thereby facilitating an opening force or a closing force to overcome frictional forces acting on the components within the rotary latch assembly. However, conventional springs are in general delicate objects, and may easily break during long periods of use or if being exposed to cold/warm temperatures or large temperature differences.

Also, in compact rotary latch assemblies, abrasive motions within the rotary latch may be induced due to frictional forces, whenever the vehicle is driving. If not taken care of properly, these abrasive motions can over time cause sufficient damage that hampers the functionality of the rotary latch assembly.

Hence, in view of the above, there is a need for a rotary latch assembly that alleviates at least some of these problems, and in particular, there is a need for a rotary latch assembly that provides a low rotary resistance, that is also compact, practical to use, and durable.

### SUMMARY

It is an object of the present invention to provide an improved solution that alleviates the mentioned drawbacks with present solutions. Furthermore, it is an object to provide a rotary latch assembly that provides a low rotary resistance, that is also compact, practical to use, and durable.

By rotary resistance, it may be meant the resistance of the rotary latch assembly an opening force or a closing force acting on the rotary latch assembly must overcome in order to position the rotary latch assembly in an open state or a closed state, respectively. The rotary resistance may be affected by, for instance, internal frictional forces as well as biasing forces acting on the components of the rotary latch assembly, in particular the latch and the pawl.

Also, by open state, it is meant that the rotary latch assembly is in a position in which it is able to receive a striker. By closed state, it is meant that the rotary latch assembly is in a position where it securely holds a striker, or in a position where it would securely hold a striker if a striker was present.

Moreover, by opening force or closing force, it may be meant the force required to actuate the rotary latch assembly to open or close. The magnitude of the opening or closing force may differ depending on where in the rotary latch assembly the opening force or closing force is applied, and in what direction relative the rotary latch assembly the opening force or closing force is applied.

According to a first aspect, a rotary latch assembly is provided comprising a latch. The latch may be rotatable about a first rotational axis R1. The latch may be rotatable about the first rotational axis R1 between a striker releasing position L1 in which the latch is positioned to release a striker, and a striker retaining position L2 in which the latch is adapted to retain the striker. The rotary latch assembly may comprise a pawl. The rotary latch may comprise an engaging member. The pawl may be rotatable about a second rotational axis R2. The pawl may be rotatable about the second rotational axis R2 between a latch engaging position P1 in which the pawl is adapted to engage with the latch, and a latch disengaging position P2 in which the engaging member is disengaged from the latch. In the latch engaging position P1, the pawl may be adapted to engage with the latch by means of the engaging member. The rotary latch assembly may comprise a latch biasing member. The latch biasing member may be adapted to bias the latch toward the striker releasing position. The rotary latch assembly may comprise a pawl biasing member. The pawl biasing member may be adapted to bias the pawl toward the latch engaging position P1.

The engaging member may be a rotatable member. The engaging member may be adapted to rotate about third rotational axis R3 defined by a rotational axle. The engaging member may be adapted to provide a rotatable interface between the latch and the pawl to facilitate the latch and the pawl to move relative each other. At least one of the latch biasing member and the pawl biasing member may be a torsion spring. At least one of the latch biasing member and the pawl biasing member may be a torsion spring with a portion that serves as the rotation axle of the engaging member. The pawl biasing member may be a torsion spring with a portion serving as the rotation axle of the engaging member. Alternatively, the latch biasing member may be a torsion spring with a portion serving as the rotation axle of the engaging member.

One advantage of the invention is that by having an engaging member adapted to provide a rotatable interface between the latch and the pawl, the rotary resistance of the rotary latch assembly may be reduced. When the latch is in a striker retaining position L1, the engaging member may engage with the latch. The engaging member may be adapted to engage with the latch, for instance by means of an engaging member receiving recess provided on the latch in which the engaging member is adapted to be received. When the engaging member engages with the latch, the pawl may be in positioned in a latch engaging position. When the pawl is moved toward the latch disengagement position, the engaging member may be initiated to disengage from the latch. Due to the rotating interface provided by the engaging member, since it is rotatable relative the third rotational axis R3, the engaging member may disengage from the latch by rolling relative the latch away from the latch. Hence, even if the rotary latch assembly is compactly designed, i.e. the latch and the pawl are arranged to tightly engage with each other, at least by means of the engaging member, in the closed state, only a minor opening force or closing force may be required to open or close the rotary latch assembly.

One advantage of the structural feature of the biasing means serving as the rotation axle for the engaging member may be that a rotatable interface is established between the latch and the pawl in an effective manner. The biasing means serving as the rotation axle of the engaging member also serves as the biasing means for the latch or the pawl, depending on which is adapted to also serve as the rotational axle for the engaging member.

One other advantage of the structural feature of the biasing means also serving as the rotation axle for the engaging member may be that it removes the necessity of implementing a more complex component apart from the latch biasing means and the pawl biasing means, which may require an increased size of the rotary latch assembly.

According to a further embodiment, the rotary latch assembly may comprise a first rivet and a second rivet serving as rotation axles for the latch and the pawl, respectively.

According to a further embodiment, the rotary latch assembly may comprise a first elastic member and a second elastic member arranged in-between the first rivet and the latch and the second rivet and the pawl, respectively.

One advantage of having an elastic member in-between a rivet and a latch or pawl may be that the impact of abrasive motions is mitigated. The durability of the rotary latch assembly may be increased. Moreover, since the impact of the abrasive motions is being mitigated by the elastic member, the level of the noise generated from the rotary latch assembly may also be reduced.

According to a second aspect, an alternative rotary latch assembly is provided. The rotary latch assembly may comprise a latch. The latch may be rotatable about a first rotational axis R1. The latch may be rotatable about the first rotational axis R1 between a striker releasing position L1 in which the latch is positioned to release a striker, and a striker retaining position L2 in which the latch is adapted to retain the striker. The rotary latch assembly may comprise a pawl. The pawl may be rotatable about a second rotational axis R2. The pawl may be rotatable about the second rotational axis R2 between a latch engaging position P1 in which the pawl is adapted to engage with the latch, and a latch disengaging position P2 in which the engaging member is disengaged from the latch. The rotary latch assembly may comprise a latch biasing member. The latch biasing member may be adapted to bias the latch toward the striker releasing position. The rotary latch assembly may comprise a pawl biasing member. The pawl biasing member may be adapted to bias the pawl toward the latch engaging position P1. The rotary latch assembly may comprise a first rivet and a second rivet serving as rotation axles for the latch and the pawl, respectively. The rotary latch assembly may comprise a first elastic member and a second elastic member arranged in-between the first rivet and the latch and the second rivet and the pawl, respectively.

One advantage of having an elastic member in-between a rivet and a latch/pawl may be that the impact of abrasive motions is mitigated. The durability of the rotary latch assembly may be increased. Moreover, since the impact of the abrasive motions is being mitigated by the elastic member, the sound level of the noise generated from the rotary latch assembly may also be reduced.

According to a further embodiment, an engaging member may be provided such that the pawl, in the latch engaging position may be adapted to engage with the latch by means of the engaging member. The engaging member may be a rotatable member. The engaging member may be adapted to rotate about an axle defining a third rotational axis R3. The engaging member may be adapted to provide a rotatable interface between the latch and the pawl when rotating about the rotation axle. The rotatable interface may facilitate the latch and the pawl to move relative each other. One of the latch biasing member and the pawl biasing member may be a torsion spring. The latch biasing member or the pawl biasing member being a torsion spring may comprise a portion that serves as the rotation axle of the engaging member.

One advantage of the invention is that by having an engaging member adapted to provide a rotatable interface between the latch and the pawl, the rotary resistance of the rotary latch assembly may be reduced. When the latch is in a striker retaining position L1, the engaging member may engage with the latch. The engaging member may be adapted to engage with the latch, for instance by means of an engaging member receiving recess provided on the latch in which the engaging member is adapted to be received. When the engaging member engages with the latch, the pawl may be in positioned in a latch engaging position. When the pawl is moved toward the latch disengagement position, the engaging member may be initiated to disengage from the latch. Due to the rotating interface provided by the engaging member, since it is rotatable relative the third rotational axis R3, the engaging member may disengage from the latch by rolling relative the latch away from the latch. Hence, even if the rotary latch assembly is compactly designed, i.e. the latch and the pawl are arranged to tightly engage with each other, at least by means of the engaging member, in the closed state, only a minor opening force or the closing force may be required to open or close the rotary latch assembly.

One advantage of the structural feature of the biasing means serving as the rotation axle for the engaging member may be that a rotatable interface is established between the latch and the pawl in an effective manner. The biasing means serving as the rotation axle of the engaging member also serves as the biasing means for the latch or the pawl, depending on which is adapted to also serve as the rotational axle for the engaging member.

One other advantage of the structural feature of the biasing means also serving as the rotation axle for the engaging member may be that it removes the necessity of implementing some more complex component apart from the latch biasing means and the pawl biasing means, which may increase the size of the rotary latch assembly.

The following embodiments are applicable to both the first aspect and the second aspect of the invention as presented above, and may thus be further embodiments of the first aspect of the invention or the second aspect of the invention.

According to some embodiments, the latch may comprise a circular-through hole through which the first rivet is adapted to be received. The latch may be adapted to rotate along a latch rotating plane about the first rivet. The latch may be adapted such that the latch rotating plane is perpendicular to the first rotational axis R1. The latch may also comprise a striker receiving recess for receiving the striker.

According to some embodiments, the pawl may comprise a circular-through hole through which the second rivet is adapted to be received. The pawl may be adapted to rotate along a pawl rotating plane about the second rivet. The pawl may be adapted such that the pawl rotating plane is perpendicular to the second rotational axis R2. The pawl may be adapted in shape so that the side facing the latch in the rotary latch assembly opens into the circular through hole. This may allow the latch and pawl to be arranged more compactly in relation to each other. The pawl may comprise a lever-portion that extends outwardly from its rotational axis. By moving the lever-portion about the second rotational axis R2, the engaging member may be forced to engage or disengage with the latch.

According to some embodiments, the latch biasing member may be a torsion spring. According to some embodiments, the pawl biasing member may be a torsion spring. Such a torsion spring may comprise a helical portion. The helical portion may be provided with a certain number of windings. The number of windings may be in the interval of one to ten, or more. The number of windings may be approximately one, two, three, four, five, six, seven, eight, nine, ten, or more. By approximately a ‘certain number’ of windings, it may be meant that the helical spring portion comprises closer to said ‘certain number’ of windings than any other integer number of windings. The helical portion may be adapted to be arranged about a rivet. Moreover, the torsion spring may comprise a first end portion and a second end portion extending out from the helical spring portion. If the latch biasing means is a torsion spring, one of its end portions may be arranged to couple to the latch. If the pawl biasing means is a torsion spring, one of its end portions may couple to the pawl. The other of the first and second end portions may be adapted to be supported, so that the torsion spring may be biased. The end portion coupled to the latch or pawl may be L-shaped. The L-shaped portion may serve as a rotation axle for the engaging member.

According to some embodiments, the latch biasing means and the pawl biasing means may be made of stainless steel. Moreover, if the latch biasing means or the pawl biasing means is a torsion spring, the torsion spring may be made of stainless steel. Moreover, the torsion spring may be characterized by a certain thickness. The torsion spring may be adapted in terms of thickness to be able to withstand a certain amount of tension as required by the biasing force it is intended to apply.

According to some embodiments, the engaging member may be a roller. By a roller, it may be meant a cylindrical component. The height and diameter of the roller may be adjusted in relation to the size and shape of the other components of the rotary latch assembly, in particular the latch and the pawl. The engaging member may be provided with an axial recess or through-hole in which the torsion spring portion is adapted to be received. Alternatively, the engaging member may be provided as a ball, an ellipsoid, or in other geometric shapes that may provide a rotatable interface between the latch and the pawl.

According to some embodiment, the recess for retaining the engagement member in the pawl may be adapted in size and shape so that the pawl extends along at least half of the engagement member's circumference when arranged in the pawl recess. By this it may be meant that the recess of the pawl may be adapted in size and shape to abut at least half of a circumferential portion facing of the engagement member. In other embodiments, the recess for retaining the engagement member in the pawl may be adapted so that the pawl extends between 50-70 percent along the engagement member's circumference when arranged in the pawl recess, or between 50-60 percent of said circumference.

According to some embodiments, the engaging member may be provided in a rigid material. The engaging member may be made of hardened steel.

According to some embodiments, the first elastic member or the second elastic member may be cylindrical in shape. Both the first elastic member and the second elastic member may be cylindrical in shape.

One advantage of having such a geometric shape, is that the elastic member may provide a greater contact region between the rivets and the latch/pawl. The elastic members may be characterized by a radial thickness. The elastic members may have different radial thicknesses. The radial thickness of either the first elastic member or the second elastic member or both may be in the interval of 0.1 mm to 1 cm.

According to some embodiments, the first elastic member and the second elastic member may have different cylindrical heights. One advantage of this may be that the first and second elastic member may be dimensioned to provide more or less protection between the rivets and the latch/pawl if necessary. Moreover, the elastic members may be adapted in relation to the size and shape of other components of the rotary latch assembly, so that the amount of wasted space is reduced, thereby allowing for a more compact rotary latch assembly.

According to some embodiments, one of the first elastic member and the second elastic member may be made of rubber. Both the first elastic member and the second elastic member may be made of rubber. One advantage of this may be that the elastic member may more effectively mitigate abrasive motions between the rivets and latch/pawl.

According to some embodiments, the rotary latch assembly may comprise a third elastic member. The third elastic member may be adapted to provide an abutting surface to a striker retained by the rotary latch assembly.

One advantage of having this third elastic member may be that the impact of abrasive motions between the striker and the rotary latch assembly is mitigated. The durability of the rotary latch assembly may thus be increased. Moreover, since the impact of the abrasive motions is being mitigated by the third elastic member, the sound level of the noise generated from the rotary latch assembly may also be reduced.

According to some embodiments, the third elastic member may be made of rubber. One advantage of this may be that the third elastic member may more effectively mitigate abrasive motions between the striker and the rotary latch assembly.

According to some embodiments, the first elastic member and the second elastic member may be interconnected by the third elastic member. By this, a single elastic member may be provided. The first elastic member, the second elastic member, and the third elastic member may each correspond to different portions of this single elastic member. By this, the manufacturing of the elastic member(s) may be more streamlined. Manufacturing speed may be increased. Manufacturing cost may be reduced.

According to some embodiments, both the latch biasing member and the pawl biasing member may be torsion springs. The same type of torsion spring may be used as the latch biasing member and the pawl biasing member. By this, only one type of torsion springs may be required when manufacturing the rotary latch assembly. The torsion springs used for the latch biasing means and the pawl biasing means may be different in some ways.

According to some embodiments, the latch biasing member and the pawl biasing member may be interconnected. The end portions of the latch biasing member and the pawl biasing member not coupled to the latch or pawl may be interconnected. By this, the latch biasing member and the pawl biasing member are provided with an intrinsic biasing support, i.e. the ends not coupled to the latch or pawl do not need to be attached to any particular position in the rotary latch assembly. By this, a simple and effective solution is provided. In one embodiment, the interconnected biasing members may have a first end that is coupled to the latch and a second end coupled to the engaging member and acting as rotation axle for the engaging member. Between the first and second end, the biasing member may comprise at least one winding around a first rivet acting as rotation axle for the latch and at least one winding around a second rivet acting as rotation axle for the pawl.

According to some embodiments, the pawl may comprise a recess for retaining the engaging member. By this, the pawl may more easily actuate the engaging member to engage or disengage with the latch.

According to some embodiments, the recess for retaining the engaging member may be located on a protrusion extending outwardly from the rotational axis R3 of the pawl.

According to some embodiments, the latch may comprise a first engaging member receiving recess for receiving the engaging member when the latch is in the striker retaining position L2.

According to some embodiments, the latch may comprise a second engaging member receiving recess for receiving the engaging member when in a position L3 in-between the striker releasing position L1 and the striker retaining position L2. By this, the rotary latch assembly may be provided with means to prevent the striker from damaging the rotary latch assembly. Moreover, by this, the rotary latch assembly may be prevented from being accidentally opened.

According to some embodiments, the latch rotating angle between the striker releasing position L1 and the striker retaining position L2 may be in the interval of 5-90 degrees, preferably 30-75 degrees, more preferably 35-60 degrees, and most preferably 40-50 degrees.

According to some embodiments, the pawl rotating angle between the latch engaging position and the latch disengaging position may be in the interval of 5-90 degrees, preferably 5-45 degrees, more preferably 10-30 degrees, and most preferably 15-25 degrees.

According to some embodiments, the rotary latch assembly may comprise a housing. By this, the latch, pawl, latch biasing means, pawl biasing means and other components of the rotary latch assembly may be effectively protected. Moreover, the housing may hold all the components together more securely. Moreover, the housing may be provided with mounting means for mounting to a door or a door frame. The mounting means may be screws or the like.

The housing may comprise a front portion and a back portion. The front portion and the back portion may be adapted to be assembled together to define a cavity there in-between. The front portion and the back portion may be adapted in shape so as to provide a cuboid cavity in-between them when assembled together. The front portion and back portion may be adapted with circular through holes for receiving the first and second rivets. The first and second rivet may be arranged so that the first rotational axis R1 and the second rotational axis R2 are parallel. The housing may comprise a striker opening. The striker opening may be formed by recesses provided on the front portion and the back portion. The recesses on the front portion and the back portion may be adapted in size and shape so that the rotary latch assembly receives a striker at a position in-between the locations of the first rivet and second rivet. The rotary latch assembly may be adapted to receive a striker in a striker receiving direction X. The rotary latch assembly may be adapted to release a striker in a striker releasing direction X′. Rotary latch assembly may be adapted in size and shape so that the striker receiving direction X and the striker releasing direction X′ are oriented opposite to each other. The rotary latch assembly may be adapted in size and shape such that the striker receiving direction X and/or the striker releasing direction X′ are oriented perpendicular to the first rotational axis R1 and/or the second rotational axis R2. The housing may be adapted in size and shape so as to limit the striker's ability to move in a direction transversal to the striker receiving direction X and/or the striker releasing direction X′.

According to some embodiments, the rotary latch assembly may comprise operating means for operating the rotary latch assembly. The operating means may be coupled to the pawl. The operating means may be adapted to apply a force on the lever-portion of the pawl. The force may be applied on the lever-portion in a tangential direction relative the rotational axis of the pawl. By applying such a force on the lever-portion of the pawl, the pawl may be moved between the latch engaging position P1 and the latch disengaging position P2. The operating means may be an actuator, for instance a linear actuator, a rotary actuator, a mechanical lever, or the like. The operating means and the pawl may be operatively coupled by means of a cable. The cable may be a routed cable. The operating means may be operated to displace the cable such that a pulling force moves the pawl from the latch engaging position P1 to the latch disengaging position P2. Alternatively, the operating means may be operated to displace the cable such that a pulling force moves the pawl from the latch disengaging position P2 to the latch engaging position P1.

According to some embodiments, the rotary latch assembly may comprise a support member adapted to extend between two opposing interior surfaces of the housing, wherein the support member is further adapted in size and shape to define ranges of movement of the latch and the pawl. By this, the latch and the pawl may be protected from, or at least being less exposed to, abrasive motions. This may improve the durability of the rotary latch assembly.

According to some embodiments, the support member may comprise a body resembling a cuboid, having a certain height, length, and width, each of which are adapted so that the support member can fit in the cuboid cavity of the housing. The support member may comprise a major recess adapted to contain the latch, the pawl and/or other components. The support member may comprise a striker recess. The striker recess may be adapted to receive the striker when being retained in the striker retaining position.

According to some embodiments, the support member may be made of plastic. The support member may be made by means of injection molding. The support member may be made by means of 3D-printing. By this, the support member may be manufactured in an efficient manner, both in terms of material waste, manufacturing cost, and manufacturing time.

According to some embodiments, the support member may be adapted to at least partly encapsulate the first elastic member, the second elastic member, the third elastic member, or any combination of them. By this, the support member may be adapted to provide support to the elastic member(s). Further, the support member may be adapted to provide a surface for the latch or pawl to rotate against, while the first or second elastic member located on the other side provides elastic functionality.

According to some embodiments, the support member may comprise a slot adapted to receive the engaging member. The slot may extend along the support member. The slot may define a guide slot which supports the engaging member in-between positions where it engages with the latch and where it is disengaged from the latch. The guide slot may be adapted to guide the engaging member along its path when moved between the two different positions corresponding to the latch engaging position P1 and the latch disengaging position P2 of the pawl. By this, the support member may also provide guidance to the engaging member when being moved between engagement and disengagement with the latch.

According to some embodiments, the support member may comprise a through-hole adapted to receive a rivet. The support member may comprise two through-holes adapted to receive the first rivet and the second rivet, respectively. By this, the support member may more easily provide support to the latch and the pawl, as well as other components.

According to some embodiments, the support member may comprise an elevated surface in-between the through-holes. By this, the latch and the pawl may more easily move about in the rotary latch assembly. One or both of the through-holes may be bounded by a hollow cylindrical portion. The cylindrical portion may be adapted to provide a surface along which the latch or the pawl may rotate along when rotating about the first rotational axis R1 or the second rotational axis R2, respectively.

According to some embodiments, the support member may comprise a latch stop adapted to limit the range of movement of the latch. By this, the latch may be prevented from being rotated beyond the striker retaining position. This may improve the durability of the rotary latch assembly.

According to some embodiments, the support member may comprise a pawl stop adapted to limit the range of movement of the pawl. By this, the pawl may be prevented from being rotated beyond the first latch engaging position. This may improve the durability of the rotary latch assembly.

According to a third aspect of the invention, a support member for a rotary latch assembly is provided. The support member may be adapted in size and shape to provide support and/or protection for a rotary latch assembly. The support member may be a support member as described in relation to the first aspect or the second aspect of the invention. The support member may be provided as a stand-alone component. By providing the support member as a stand-alone component, a worn support member in a rotary latch assembly may be replaced by a new support member. The support member may facilitate a latch and a pawl to move about in the rotary latch assembly by reducing friction. This reduces the rotary resistance of the rotary latch. Moreover, since the support member provides support to the components of the rotary latch assembly, it also reduces the abrasive motions within the rotary latch assembly.

According to some embodiments, the support member may comprise the first elastic member, the second elastic member, the third elastic member, as herein described, or any combination of them.

According to some embodiment, the support member and the elastic member(s) may be formed as an integral component. By this, the support member and the elastic member(s) may be more cheaply produced.

According to a fourth aspect of the invention, a door or a door frame comprising a rotary latch assembly as herein described is provided. By this, the door or the door frame may be securely shut and may be opened or closed by a weaker opening force or a closing force.

According to a fifth aspect of the invention, a vehicle having a door comprising a rotary latch assembly as herein described is provided. By this, the door or the door frame of the vehicle may be securely shut and may be opened or closed by a weaker opening force or a closing force. A plurality of doors may be provided with such a rotary latch.

The invention is defined by the appended independent claims, with embodiments being set forth in the appended dependent claims, in the following description and in the drawings.

### BRIEF DESCRIPTION OF THE DRAWINGS

The invention will in the following be described in more detail with reference to the enclosed drawings, wherein:

FIG. 1 shows a perspective front view of a rotary latch assembly according to an embodiment of the invention;

FIG. 2 shows a perspective back view of a rotary latch assembly according to an embodiment of the invention;

FIG. 3a shows a side view of a rotary latch assembly according to an embodiment of the invention as seen from the top;

FIG. 3b shows a side view of a rotary latch assembly according to an embodiment of the invention as seen from the left;

FIG. 3c shows a side view of a rotary latch assembly according to an embodiment of the invention as seen from the front;

FIG. 3d shows a side view of a rotary latch assembly according to an embodiment of the invention as seen from the right;

FIG. 3e shows a side view of a rotary latch assembly according to an embodiment of the invention as seen from the bottom;

FIG. 4a shows a perspective front view of a rotary latch assembly according to an embodiment of the invention when the housing is omitted;

FIG. 4b shows a perspective back view of a rotary latch assembly according to embodiment of the invention when the housing is omitted;

FIG. 5a shows a front view of a rotary latch assembly according to an embodiment of the invention when the housing is omitted;

FIG. 5b shows a back view of a rotary latch assembly according to an embodiment of the invention when the housing is omitted;

FIGS. 6a-6i show the working principle of a rotary latch assembly according to an embodiment of the invention;

FIG. 7a shows a perspective back view of a support member according to an embodiment of the invention;

FIG. 7b shows a perspective front view of a support member according to an embodiment of the invention;

FIG. 8 shows a cross sectional view of a support member according to an embodiment of the invention;

FIG. 9 shows a cross sectional view of a rotary latch assembly according to an embodiment of the invention;

FIGS. 10a-10b show a perspective front and back view respectively of a rotary latch assembly according to an embodiment of the invention;

FIGS. 11a-11b show a perspective front and back view of the rotary latch assembly according to an embodiment of the invention when the housing is omitted;

FIGS. 12a-12b show a back view of the rotary latch assembly according to an embodiment of the invention when some components have been omitted, and

FIGS. 13a-13b show perspective views of support members according to an embodiment of the invention.

### DESCRIPTION OF EMBODIMENTS

The present invention will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements.

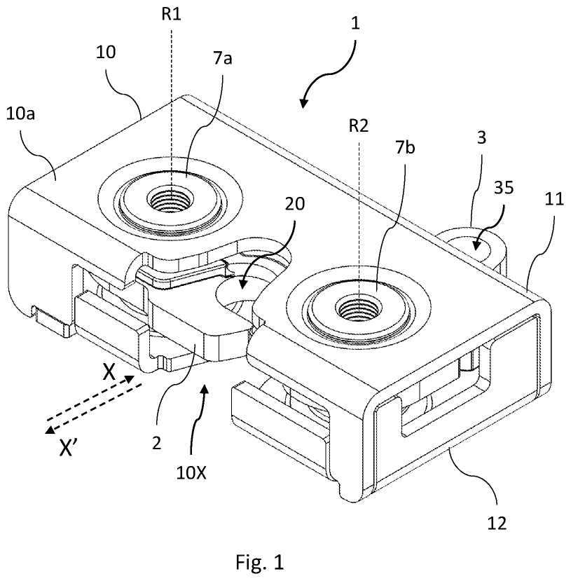

The rotary latch assembly 1 according to one exemplary embodiment of the invention is described in the following in reference to FIGS. 1 and 2. The rotary latch assembly 1 comprises a latch 2, a pawl 3, a latch biasing means 4, a pawl biasing means 5, and an engaging member 6. The latch 2 is rotatable about a first rotational axis R1 between a striker releasing position L1 in which the latch 2 is positioned to release a striker 20X, and a striker retaining position L2 in which the latch 2 is adapted to retain the striker 20X to the housing 10. The pawl 3 is rotatable about a second rotational axis R2 between a latch engaging position P1, P3 in which the pawl 3 is adapted to engage with the latch 2 by means of the engaging member 6, and a latch disengaging position P2 in which the engaging member 6 is disengaged from the latch 2. The latch biasing member 4 is adapted to bias the latch 2 toward the striker releasing position L1, and the pawl biasing member 5 is adapted to bias the pawl 3 toward the latch engaging position P1. Moreover, the engaging member 6 is a rotatable member rotatable about a rotation axle, and adapted to provide a rotatable interface 60 between the latch 2 and the pawl 3 to facilitate the latch 2 and the pawl 3 to move relative each other. Also, the pawl biasing member 5 is a torsion spring with a portion 50 that serves as the rotation axle of the engaging member 6. The rotatable interface 60 provided by the rotatable engaging member 6 facilitates the latch 2 and the pawl 3 when disengaging from each other, i.e. the magnitude of the opening force is effectively reduced even if the rotary latch assembly is very compact in design. Moreover, by having the engaging member 6 being rotatable about the pawl biasing member, a simple and compact design is achieved. Moreover, the engaging member provides a buffer in-between the latch 2 and the pawl 3, so as to mitigate abrasive motions that may occur there in-between.

As shown in FIGS. 1 and 2, the rotary latch assembly 1 comprises a housing 10. The housing 10 offers a protective casing to the components therein, while also offering suitable mounting means to a door or a door frame. The housing 10 is constituted by a front portion 11 and a back portion 12 which are adapted to be assembled together to define a cuboid cavity there in-between. By having two separate housing portions, a front portion 11 and a back portion 12, the latch 2, the pawl 3, the latch biasing means 4, the pawl biasing means 5, the engaging member 6, etc. are more easily placed inside cuboid cavity of the housing 10. As will be evident in the following description, the housing 10 is adapted to house other components as well.

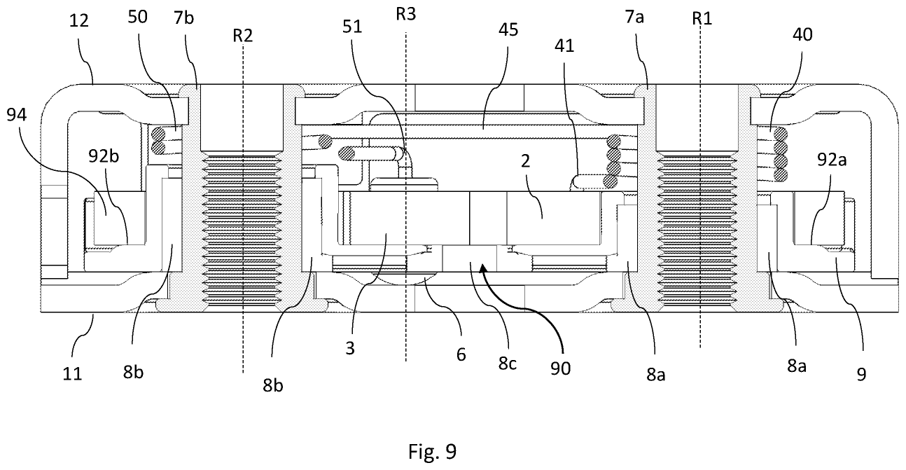

The front portion 11 and the back portion 12 of the housing 10 are each provided with two circular holes. The holes of the front portion 11 and the back portion 12 are adapted to receive a first and a second rivet 7a, 7b which function as the rotational axles for the latch 2 and the pawl 3, respectively. The first rivet 7a and the second rivet 7b extend through the holes of the front side 11 of the housing to the back side 12 of the housing, as shown in FIGS. 1 and 2, and in particular FIG. 9 which shows a cross sectional view of the rotary latch assembly 1, wherein the cross sectional plane intersects each rivet 7a, 7b. When assembling the housing 10, the holes of the front portion 11 and the holes of the back portion 12 are aligned as seen from the front. Hence, the rivets 7a, 7b placed therein are arranged parallel, as is shown in FIG. 9. Moreover, the rivets 7a, 7b may hold the front portion 11 and the back portion 12 together with all the components securely arranged inside.

The latch 2 comprises a striker receiving recess 20 for receiving the striker 20X when placed therein. The latch 2 comprises a circular through-hole, and the latch 2 is adapted to be arranged to the first rivet 7a so that the first rivet 7a extends through the circular through-hole of the latch 2. Moreover, the latch comprises an engaging member receiving recess 21 for receiving the engaging member 6 when the latch 2 is in the striker retaining position L2. The latch 2 also comprises a second engaging member receiving recess 22 for receiving the engaging member 6, when in a position L3 in-between the striker releasing position L1 and the striker retaining position L2. The position L3 in-between the striker releasing position L1 and the striker retaining position L2 provides an additional safety measure, as it may hinder the striker 20X from being fully released from the rotary latch if the pawl 3 is accidentally actuated toward the latch disengaging position P2.

Also, the pawl 3 comprises a circular through-hole, and the pawl 3 is adapted to be arranged to the second rivet 7b so that the second rivet 7b extends through the circular through-hole of the pawl 3. Also, the pawl 3 comprises a recess 30 for retaining the engaging member 6. The recess 30 for retaining the engaging member 6 is located on a protrusion 31 extending outwardly from the rotational axis R3 of the pawl 3. The recess 30 is located a distance from the second rotational axis R2. The protrusion 31 may be adapted in size and shape so as to increase or decrease the distance between the recess 30 and the second rotational axis R2, so as to increase or decrease the angular travel distance of the engaging member 6, when the pawl 3 is moved in-between the latch engaging position P1 and the latch disengaging position P2.

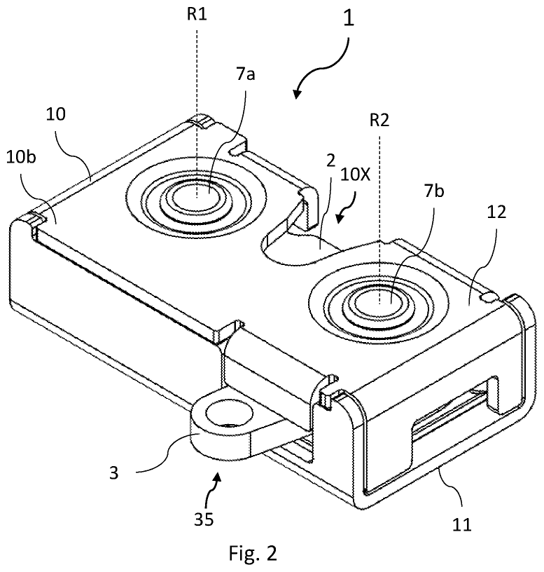

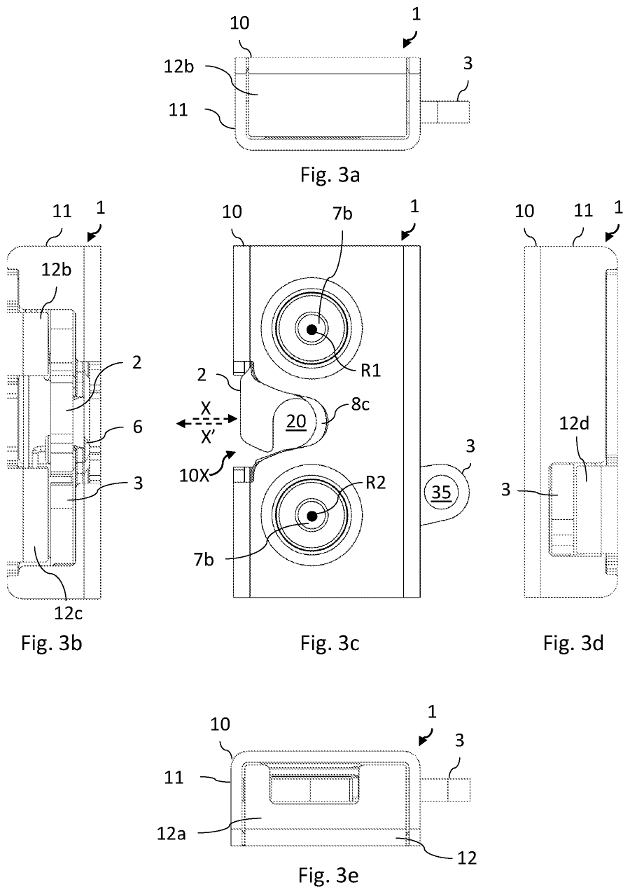

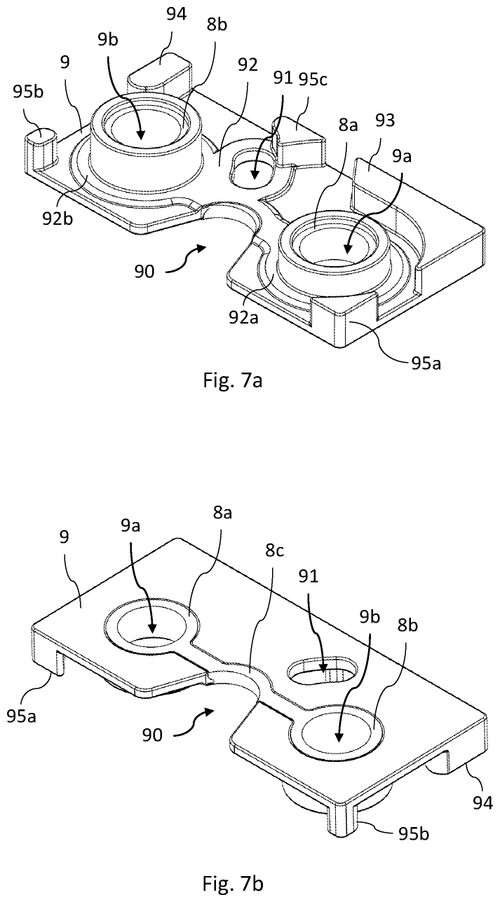

The housing 10 comprises a striker opening 10X. The striker opening 10X is formed by recesses provided on the front portion 11 and the back portion 12, respectively. The recesses on the front portion 11 and the back portion 12 allow a striker to be received at a location in-between the rivets 7a, 7b. The housing 10 is adapted to receive a striker 20X in the striker opening 10X along a striker receiving direction X as shown in e.g. FIGS. 1, 3c. The striker 20X may be released from the housing 10 along a striker releasing direction X′ as shown in e.g. FIGS. 1, 3c. The striker receiving direction X and the striker releasing direction X′ are oriented opposite to each other. The housing 10 is adapted in size and shape so as to limit the striker's 20X ability to move in a direction transversal to the striker receiving direction X and the striker releasing direction X′. As will be discussed in more detail in reference to FIGS. 7a, 7b, 8, 9, the rotary latch assembly 1 comprises an elastic member 8c which supports the striker 20X when retained in the striker receiving recess 20.

The right side of housing 10 as viewed from the front (see FIG. 3c, FIG. 3d) is provided with an opening through which the pawl 3 is adapted to protrude. On this protruding end of the pawl 3, a circular through-hole 35 is provided (see FIG. 2, FIG. 3c). Operating means may be coupled to the pawl 3 via the circular through-hole 35 to operatively control the pawl 3 to move between the latch engaging position P1 and the latch disengaging position P2. Such operating means may be an actuator, for instance a linear actuator, a rotary actuator, a mechanical lever, or the like. The operating means and the pawl 3 may be connected to each other by means of a cable, for instance a routed cable. The operating means may be operated to displace the cable to apply a pulling force on the pawl 3 to move the pawl 3 towards the latch disengaging position P2.

In FIGS. 3a-3e, the rotary latch assembly 1 is illustrated as seen in different perspectives. FIG. 3a shows the top side surface of the housing 10, FIG. 3b shows the left side surface of the housing 10, FIG. 3c shows the front side surface of the housing 10, FIG. 3d shows the right side surface of the housing 10, and FIG. 3e shows the bottom side surface of the housing 10. The housing 10 is provided with a plurality of curved edges, as can be seen in FIGS. 3a-3e. FIGS. 3a and 3e show that the back side surface of the housing 10 curves toward the left side surface (FIG. 3b) and the right side surface (FIG. 3d) of the housing 10, respectively. FIGS. 3b and 3d show that the front side surface of the housing 10 curves toward the top side surface (FIG. 3a) and the bottom side surface (FIG. 3e). The top side surface (FIG. 3a), the left side surface (FIG. 3b), the right side surface (FIG. 3d) and the bottom side surface (FIG. 3e) are defined by a combination of the front portion 11 and the back portion 12.

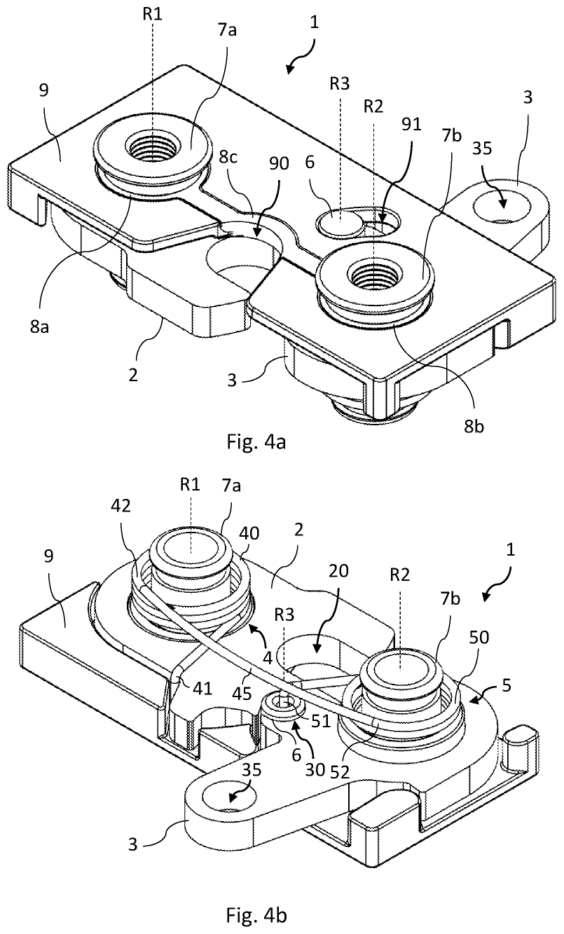

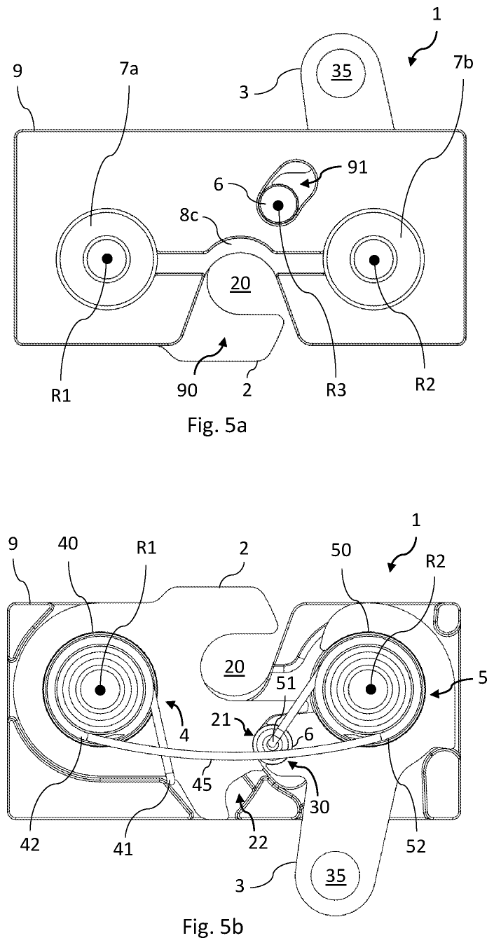

FIGS. 4a-4b, 5a-5b, show the rotary latch assembly 1′, in which figures the housing 10 of the rotary latch assembly 1 has been omitted. FIGS. 4a-4b show perspective views of the front and back of the rotary latch assembly 1′, respectively. FIG. 5a show a front view of the rotary latch assembly 1′, while FIG. 5b show a back view of the rotary latch assembly 1′.

In FIGS. 4a-4b, 5a-5b, some more components of the rotary latch assembly 1 are shown. As previously stated, the rotary latch assembly 1 comprises the latch 2, the pawl 3, the latch biasing member 4, the pawl biasing member 5, the engaging member 6. The rotary latch assembly 1 also comprises a first rivet 7a, and a second rivet 7b. Moreover, the rotary latch assembly 1 comprises elastic members 8a, 8b, 8c and a support member 9, which will be described in more detail in reference to FIG. 7a, 7b, 8, 9. It may however be briefly stated that the elastic members 8a, 8b, 8c and the support member 9 provide various means for improving the durability of the rotary latch assembly 1. Also, the support member 9 comprises a slot 91 adapted to guide the engaging member 6 along its path when moved between the two different positions corresponding to the latch engaging position P1 and the latch disengaging position P2 of the pawl 3.

In FIG. 4b, the latch biasing means 4 and the pawl biasing means 5 are shown. The latch biasing means 4 and the pawl biasing means 5 are torsion springs. Each of them have a helical portion 40, 50 through which each respective rivet 7a, 7b extends through. The helical portions 40, 50 are provided with a certain number of windings. The helical portion 40 associated with the latch 2 comprises approximately four windings. By approximately four windings, it is meant that the helical portion 40 associated with the latch 2 comprises closer to four windings than three or five windings. The helical portion 50 associated with the pawl 3 comprises approximately two windings. By approximately two windings, it is meant that the helical portion 50 associated with the pawl 3 comprises closer to two windings than one or three windings. The number of windings may affect the stiffness of the biasing means. The latch biasing means 4 comprises a L-shaped end portion 41 which extends out from the helical portion 40. The L-shaped end portion 41 is arranged to abut the latch 2 on an inner side facing into the housing 10. The latch biasing means 4 is pre-biased, meaning that the latch biasing means 4 will force the latch 2 to move toward the striker releasing position L1. Likewise, the pawl biasing means 5 comprises a L-shaped end portion 51 which extend out from the helical portion 50 of the pawl biasing means 5. The L-shaped end portion 51 is adapted to serve as a rotation axle for the rotatable engaging member 6 so as to enable the engaging member 6 to rotate about a third rotational axis R3. By this, a simple and compact design is achieved. Moreover, the pawl 3 is provided with an engaging member recess 30 adapted to retain the engaging member 6. Thus, the pawl biasing member 5 is biasing the pawl 3 via the engaging member 6 to rotate into a latch engaging position P1, P3.

Additionally, the latch biasing member 4 and the pawl biasing member 5 are interconnected by a connecting spring portion 45. The connecting spring portion 45 connects to the helical portions 40, 50 of the latch biasing member 2, the pawl biasing member 3, via helical end portions 42, 52. Hence, a single torsion spring comprising the latch biasing means 4 and the pawl biasing means 5.

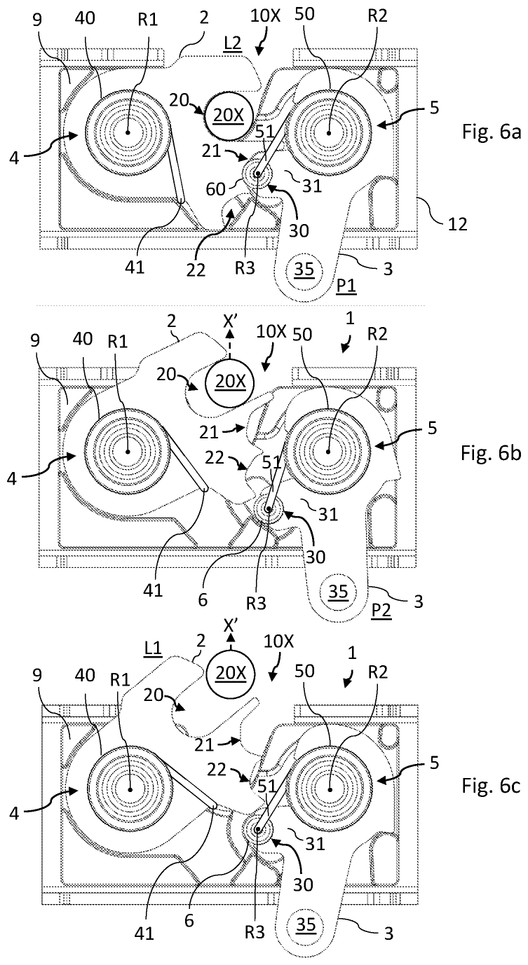

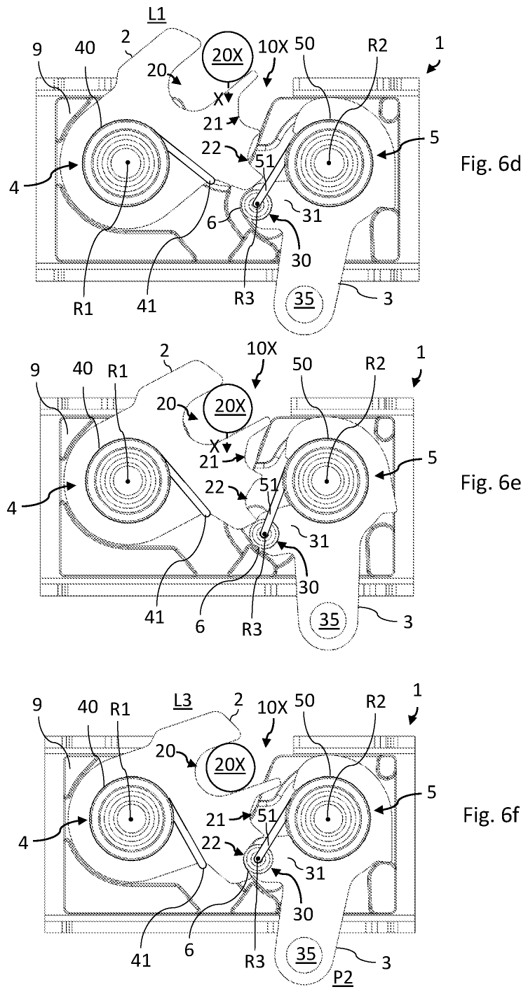

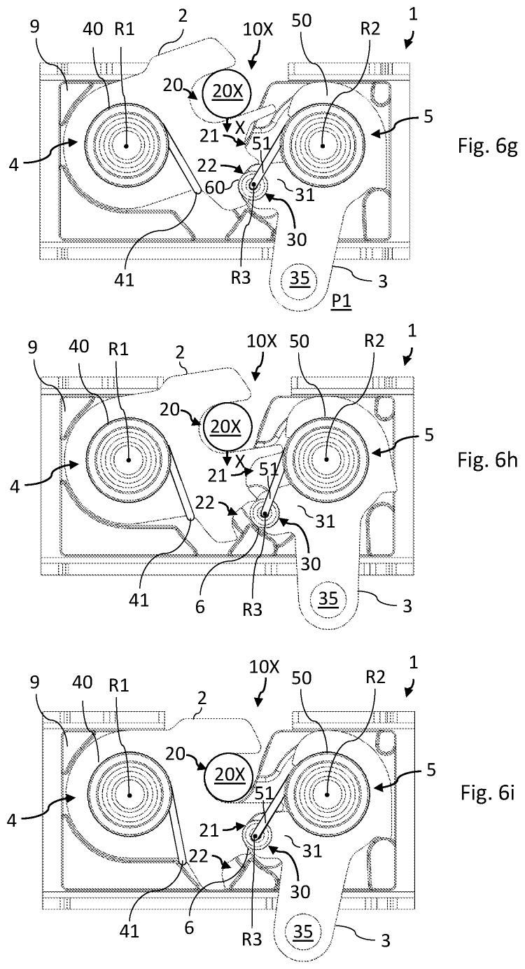

The working principle of the rotary latch assembly 1 is described in the following in reference to FIGS. 6a-6i. In these figures, the connecting spring portion 45 has been omitted in order to more clearly illustrate the components underneath.

In FIG. 6a, the rotary latch assembly 1 is shown retaining a striker 20X in the striker retaining recess 20 of the latch 2. The latch 2 is positioned in the striker retaining position L2. The latch 2 is shaped in size and formed so that the striker retaining recess 20 in this position opens up in a direction to the right in FIG. 6a. Since the striker 20X is retained in the striker retaining recess 20, and the striker retaining recess 20 opens up to the right in FIG. 6a, the striker 20X is unable to be displaced from the rotary latch assembly 1 in a striker releasing direction X′. Also, the striker 20X is prevented from being displaced in transversal directions relative the striker releasing direction X′ due to the shape of the housing 10, when held in the striker retaining recess 20.

In FIG. 6b, the pawl 3 is rotated from the latch engaging position P1 to the latch disengaging position P2, in which position the engaging member 6 is displaced from the first receiving recess 21. When rotating the pawl 3 from the latch engaging position P1 to the latch disengaging position P2, the engaging member 6 is caused to rotate about the third rotational axis R3. By this, the engaging member 6 basically rolls out of the first engaging member receiving recess 21. The latch 2, now freely rotatable, rotates from the striker retaining position L2 in a direction towards the striker releasing position L1 under influence of the latch biasing means 4. By this, the striker 20X is allowed to move along a striker releasing direction X′.

In FIG. 6c, the latch 2 is positioned in the striker releasing position L1. In this position, the striker retaining recess 21 opens up into the exterior of the rotary latch assembly 1 such that the striker 20X is free to move in the striker releasing direction X′. The pawl 3, which is biased toward a latch engaging position P1 by the pawl biasing means 5, is pushed toward the latch 2. However, due to the orientation of the latch 2, the engaging member 6 is unable to be placed in either the first engaging member retaining recess 21 or the second engaging member retaining recess 22. Basically, it is placed behind the latch 2, as seen when looking into the rotary latch assembly 1 through the striker opening 10X.

In FIG. 6d, the striker 20X is instead moved toward the latch 2 of the rotary latch assembly 1 along a striker receiving direction X. The striker 20X starts to press onto an interior edge of the striker retaining recess 20. Consequently, the latch 2 will start to rotate about the first rotational axis R1. The latch 2 will in turn press onto the protruding portion 31 of the pawl 3, causing it to rotate about the second rotational axis R2 from its resting position to the latch disengaging position P2.

In FIG. 6e, the striker 20X has moved further into the striker retaining recess 20. Consequently, the latch 2 has rotated into a position where it engages with the engaging member 6. When the striker 20X moves further along the striker receiving direction X, the latch 2 will rotate further into the housing 10. The engaging member 6 will in turn start to rotate about the third rotational axis R3, thereby facilitating the latch 2 to move toward the striker retaining position L2 although it is meeting a counterforce from the engaging member 6 due to the pawl biasing member 5.

In FIG. 6f, the striker 20X has moved a certain distance along the striker receiving direction X that has caused the latch 2 to have rotated relative the housing 10 into a position where the second engaging member retaining recess 22 has received the engaging member 6.

In FIG. 6g, the striker 20X is caused to move beyond the position shown in FIG. 6g along the striker receiving direction X. The latch 2 consequently rotates about the first rotational axis R1 and is moved further into the housing 10. The latch 2, as it rotates about the first rotational axis R1, pushes onto the pawl 3 and the engaging member 6, so that the pawl 3 rotates about the second rotational axis R2 from the latch engaging position P1 toward the latch disengaging position P2.

In FIG. 6h, the striker 20X has been pushed a distance further into the striker opening 10X along the striker receiving direction X. Consequently, the latch 2 has rotated a bit further about the first rotational axis R1. The latch 2 in turn engages with the engaging member 6. If the striker 20X is pushed further into the striker opening 10X, the engaging member 6 starts to rotate about the third rotational axis R3 so that the latch 2 more easily can reach the striker retaining position L2.

In FIG. 6i, the striker 20X is securely retained in the striker retaining recess 20. Even if being forced to move in the striker releasing direction X′, the latch 2 will not rotate since it is secured in position by the pawl 3 which has been moved under influence of the pawl biasing means 5 into the latch engaging position P1. Only by rotating the pawl 3 about the second rotational axis R2 a certain angle so that the engaging member 6 is moved out of the first engaging member receiving recess 21 can the striker 20X start to move along the striker releasing direction X.

As previously stated, the rotary latch assembly 1 comprises a support member 9. These will now be described in reference to FIGS. 7a-7b, 8, and FIG. 9. Generally, the support member 9 comprises a body resembling a cuboid, having a certain height, length, and width, each of which are adapted so that the support member 9 can fit in the cuboid cavity of the housing 10. Moreover, the support member 9 is adapted in size and shape with recesses that define ranges of movement of the latch 2 and the pawl 3. The support member 9 comprises a major recess, and two circular through-holes 9a, 9b in the major recess. The two through-holes are adapted to receive the first rivet 7a and the second rivet 7b, respectively. Each through-hole 9a, 9b is bounded by a hollow cylindrical portion that extends out of the major recess of the support member 9. Around each cylindrical portion, in the major recess, there is provided an elevated surface 92. The elevated surface 92 is adapted to provide a suitable surface for the latch 2 and the pawl 3 to move along when being rotated. The guide slot 91 adapted to retain the engaging member 6, and to define its range of movement is enclosed by this elevated surface 92. This facilitates the latch 2 and the pawl 3 being moved in the vicinity of the guide slot 91. Moreover, the elevated surface 92 extends in-between the two cylindrical portions, and around each cylindrical portion in respective cylindrical elevated surface portions 92a, 92b. The support member 9 also comprises a striker recess 90. The striker recess 90 extends into a position in-between the cylindrical portions bounding the circular through-holes 9a, 9b. The support member 9 comprises a first support piece 95a and a second support piece 95b. The first support piece 95a and the second support piece 95b are arranged in opposite corners along the edge at which the striker recess 90 is located. The support member 9 also comprises a latch stop 93 adapted to limit the range of movement of the latch 2 in the housing 10. The support member 9 also comprises a pawl stop 94 adapted to limit the range of movement of the pawl 3 in the housing 10. The latch stop 93 and the pawl stop 94 are arranged in the remaining two corners of the support member 9. Also, the support member 9 comprises a third support piece 96. The third support piece 96 is arranged in-between the latch stop 93 and the pawl stop 94. The first, second, and third support piece 95a, 95b, 95c and the latch stop 93 and the pawl stop 94 are all provided with the same height, as measured from the major recess.

The rotary latch assembly 1 also comprises elastic member(s) 8, 8a, 8b, 8c. The rotary latch assembly 1 comprises a first elastic member 8a. The first elastic member 8a comprises a cylindrical portion. The first elastic member 8a is adapted to be arranged in-between the first rivet 7a and the latch 2. The rotary latch assembly 1 comprises a second elastic member 8b. The second elastic member 8b comprises a cylindrical portion. The second elastic member 8b is adapted to be arranged in-between the second rivet 7b and the pawl 3. The rotary latch assembly 1 comprises a third elastic member 8c. The third elastic member 8c is adapted to be arranged in the striker recess 90. The third elastic member 8c is adapted to prevent the striker 20X from being inserted to heavily into the striker opening The bridge portion 8c is adapted to be exposed in the striker recess 90, thereby providing a flexible receiving surface for the striker 20X when positioned into the striker retaining recess 20.

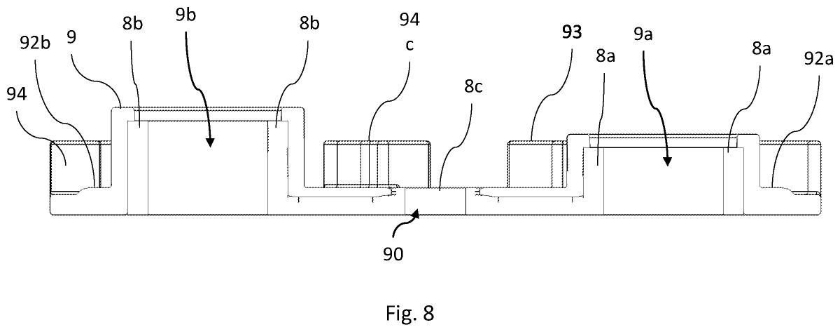

Moreover, the first elastic member 8a, the second elastic member 8b, and the third elastic member 8c are formed as an integral part, i.e. an elastic member 8. The support member 9 and the elastic member 8, i.e. the first elastic member 8a, the second elastic member 8b, and the third elastic member 8c, are also formed as an integral piece, as shown in FIG. 8. The elastic member(s) 8, 8a, 8b, 8c are made of rubber. The support member 9 is made of plastic.

FIG. 9 shows a cross sectional view of the rotary latch assembly 1 when the cross section is taken along a plane parallel to the first rotational axis R1 and the second rotational axis R2. In FIG. 9, the support member 9 is shown when mounted accordingly in the housing 10. In particular, the cylindrical portions of the support member 9 bounding the circular through-holes through which the rivets 7a, 7b are inserted, are shown having different heights. Moreover, the elastic members 8a, 8b also have different heights. The second elastic member 8b has an increased height as compared to the first elastic member 8a. This is done to compensate for the different numbers of windings of the helical portions 40, 50 of the latch biasing means 4 and the pawl biasing means 5. The number of winding of the helical portions 40, 50 of the latch biasing means 4 and the pawl biasing means 5 are adapted for the required stiffness of each biasing member. The helical portion of the pawl biasing means 5 may be provided with a lower number of windings as compared to the helical portion of the latch biasing means 4 in order to be more easily rotated in-between the latch engaging position P1 and the latch disengaging position P2. The helical portion of the latch biasing means 4 may be provided with a certain number of windings to provide a certain biasing force acting on the latch 2. The biasing force of the latch biasing means 4 may affect how easily the latch 2 is moved from the striker retaining position L2 and the striker releasing position L1.

The rotary latch assembly 1 is adapted to be mounted to a vehicle door to engage with a striker 20X arranged to a vehicle door frame. In an alternative embodiment, the rotary latch assembly 1 is adapted to be mounted to a vehicle door frame to intact with a striker 20X arranged to a vehicle door. Moreover, the rotary latch assembly 1 may be used for trunk compartments and other vehicle applications.

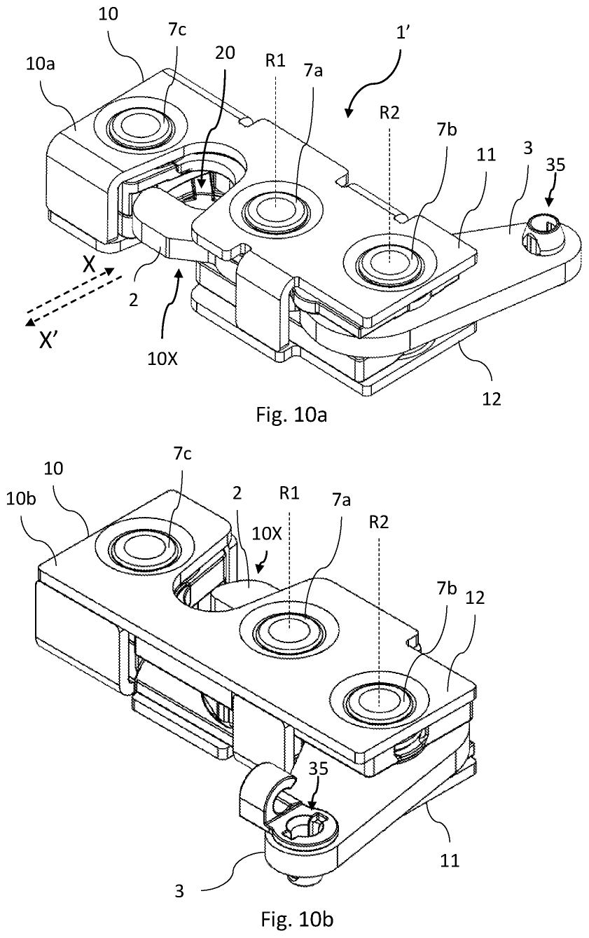

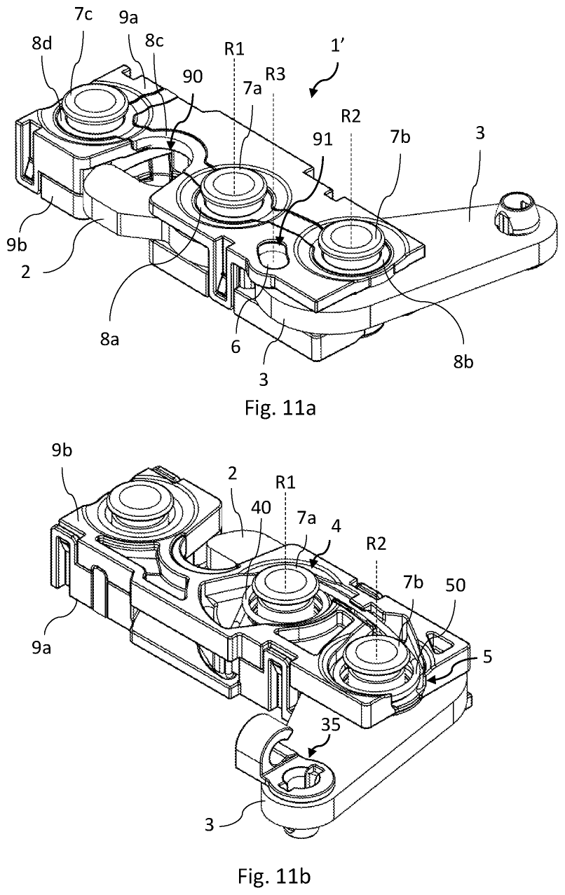

In the following, an additional embodiment of the invention is described in reference to FIGS. 10a, 10b, 11a, 11b, 12a, 12b, 13a, 13b. The rotary latch assembly 1′ is similar to the previously disclosed rotary latch assembly 1 in that it comprises a latch 2, a pawl 3, a latch biasing means 4, a pawl biasing means 5, and an engaging member 6. It may also comprise a housing 10 and a support member 9a, 9b. Like the previously disclosed embodiment, the latch 2 is rotatable about a first rotational axis R1 between a striker releasing position in which the latch 2 is positioned to release a striker, and a striker retaining position in which the latch 2 is adapted to retain the striker to the housing 10. Further, the pawl 3 is also rotatable about a second rotational axis R2 between a latch engaging position in which the pawl 3 is adapted to engage with the latch 2 by means of the engaging member 6, and a latch disengaging position in which the engaging member 6 is disengaged from the latch 2. The latch biasing member 4 is adapted to bias the latch 2 toward the striker releasing position, and the pawl biasing member 5 is adapted to bias the pawl 3 toward the latch engaging position.

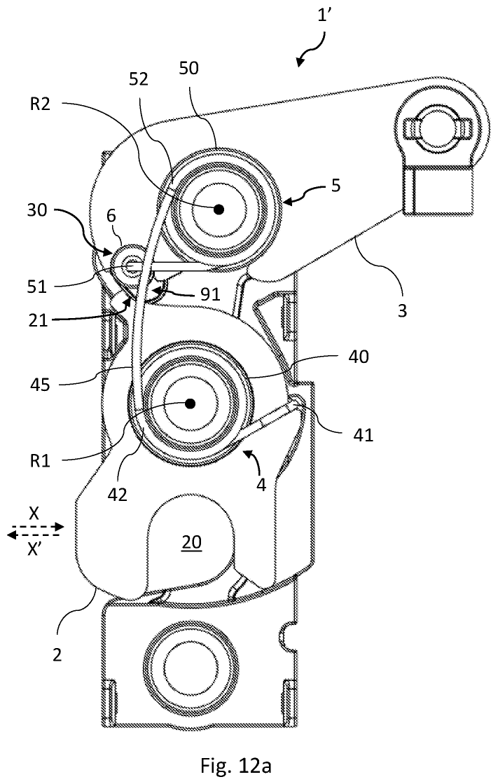

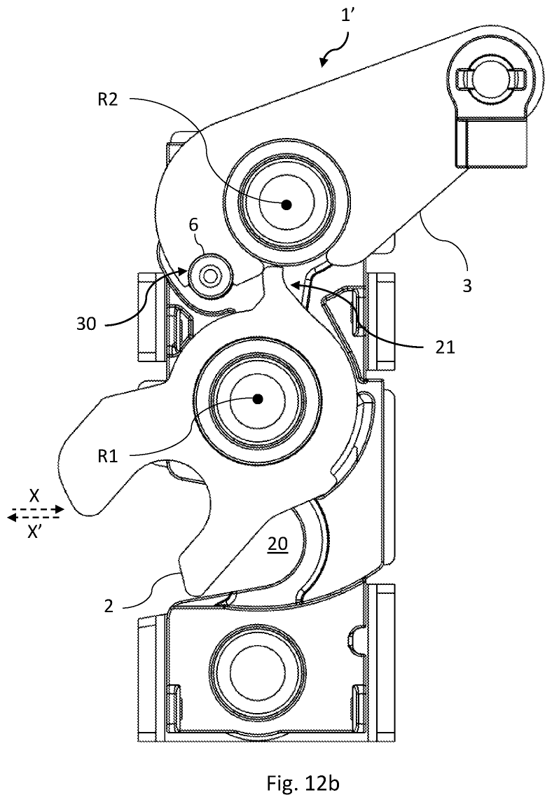

This additional embodiment 1′ of the rotary latch assembly differs from the previously disclosed embodiment 1 in that the latch 2 is configured to face away from the pawl 3 when in the striker retaining position, see FIG. 12a, 12b. This embodiment is configured to satisfy the requirements of the AR1-hole pattern standard common in the field of invention. Further, in accordance with the AR1-hole pattern standard, this additional embodiment implements only one engaging member retaining recess 21 on the latch 2 for retaining the engaging member 6. When the latch 2 is moved to the striker releasing position in which the latch 2 is positioned to release a striker, the pawl 3 may engage with the latch 2 to prevent it from returning to the striker retaining position. The pawl 3 may be configured to engage directly with a portion of the latch 2 to prevent it from returning to the striker retaining position, see FIG. 12b. Since the pawl 3 is biased against the latch 2 by means of pawl biasing member 5, the latch may, if pushed into the housing with a force of sufficient magnitude, the latch 2 may push the pawl 3 out of the way to allow the latch 2 to return to the striker retaining position.

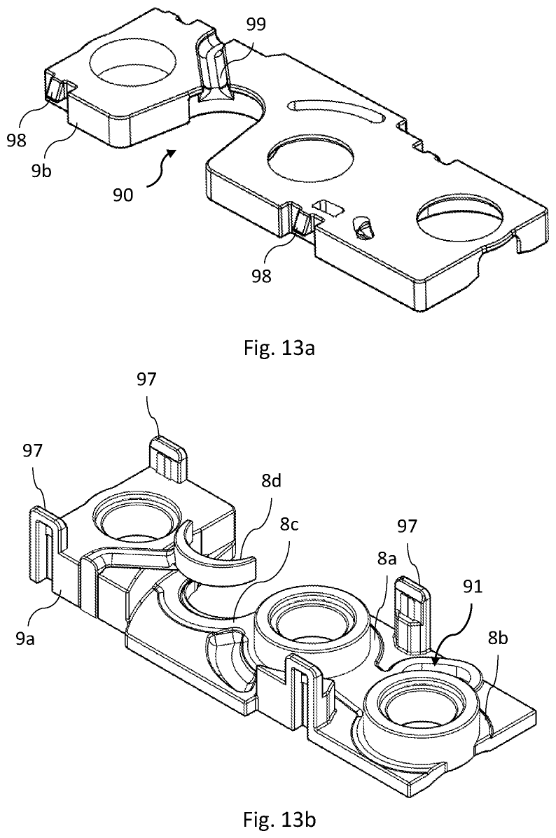

Further, similar to the previously disclosed embodiment 1, the additional embodiment 1′ comprises a support member 9a and elastic members 8a, 8b, 8c, see e.g. FIGS. 13a, 13b. However, in the additional embodiment 1′, the elastic members 8a, 8b, 8c are rearranged as compared to the previously disclosed embodiment 1 (see FIG. 13b and FIGS. 7a-7b. Further, the additional embodiment 1′ comprises an additional elastic member 8d which extends out of the support member 9a and comprises a portion similar in shape to elastic member 8c, which is also configured to provide support to the striker when retained by the rotary latch assembly 1′. The additional embodiment 1′ also comprises a second support member 9b. The first and second support members 9a, 9b are configured to at least partly encapsulate the latch 2 and the pawl 3 between them. The second support member 9b comprises a recess 99 configured to receive a portion of the additional elastic member 8d. Also, the first support member 9a comprises a set of flexible clamps 97 configured to engage in a latching manner with a corresponding set of protrusions 98 of the second support member 9b.

In the drawings and specification, there have been disclosed preferred embodiments and examples of the invention and, although specific terms are employed, they are used in a generic and descriptive sense only and not for the purpose of limitation, the scope of the invention being set forth in the following claims.

1. A rotary latch assembly, comprising:
a latch rotatable about a first rotational axis between a striker releasing position in which the latch is positioned to release a striker, and a striker retaining position in which the latch is adapted to retain the striker,
a pawl rotatable about a second rotational axis between a latch engaging position in which the pawl is adapted to engage with the latch by means of an engaging member, and a latch disengaging position in which the engaging member is disengaged from the latch, and
a latch biasing member adapted to bias the latch toward the striker releasing position, and
a pawl biasing member adapted to bias the pawl toward the latch engaging position,
wherein the engaging member is a rotatable member rotatable about a rotation axle, and adapted to provide a rotatable interface between the latch and the pawl to facilitate the latch and the pawl to move relative each other,
wherein at least one of the latch biasing member and the pawl biasing member is a torsion spring with a portion that serves as the rotation axle of the rotatable member.

2. The rotary latch assembly according to claim 1, wherein the engaging member is a roller.

3. The rotary latch assembly according to any of claims 1-2, comprising two rivets serving as rotation axles for the latch and the pawl to rotate about.

4. The rotary latch assembly according to claim 3, comprising a first elastic member and a second elastic member arranged in-between the rivets and the latch and the pawl, respectively.

5. The rotary latch assembly according to claim 4, wherein the first and second elastic members are made of rubber.

6. The rotary latch assembly according to claim 1, wherein both the latch biasing member and the pawl biasing member are torsion springs.

7. The rotary latch assembly according to claim 1, wherein the latch biasing member and the pawl biasing member are interconnected.

8. The rotary latch assembly according to claim 1, wherein the pawl comprises a recess for retaining the engaging member, wherein the recess is adapted in size and shape so that the pawl extends along at least half of the engagement member's circumference when arranged in the pawl recess, or between 50-70 percent of said circumference, or between 50-60 percent of said circumference.

9. The rotary latch assembly according to claim 1, wherein the latch comprises a first engaging member receiving recess for receiving the engaging member when the latch is in the striker retaining position.

10. The rotary latch assembly according to claim 9, wherein the latch comprises a second engaging member receiving recess for receiving the engaging member when in a position in-between the striker releasing position and the striker retaining position.

11. The rotary latch assembly according to claim 1, further comprising a housing, and a support member adapted to extend between two opposing interior surfaces of the housing, wherein the support member is further adapted in size and shape to define ranges of movement of the latch and the pawl.

12. The rotary latch assembly according to claim 11, wherein the support member at least partly encapsulates the elastic members.

13. The rotary latch assembly according to any of claims 11-12, wherein the support member comprises a slot adapted to receive the engaging member.

14. The rotary latch assembly according to claim 1, wherein the support member is made of plastic.

15. A vehicle door comprising a rotary latch assembly comprising:
a latch rotatable about a first rotational axis between a striker releasing position in which the latch is positioned to release a striker, and a striker retaining position in which the latch is adapted to retain the striker,
a pawl rotatable about a second rotational axis between a latch engaging position in which the pawl is adapted to engage with the latch by means of an engaging member, and a latch disengaging position in which the engaging member is disengaged from the latch, and
a latch biasing member adapted to bias the latch toward the striker releasing position, and
a pawl biasing member adapted to bias the pawl toward the latch engaging position,
wherein the engaging member is a rotatable member rotatable about a rotation axle, and adapted to provide a rotatable interface between the latch and the pawl to facilitate the latch and the pawl to move relative each other,
wherein at least one of the latch biasing member and the pawl biasing member is a torsion spring with a portion that serves as the rotation axle of the rotatable member.
